(19) United States
(12) Patent Application Publication
(10) Pub. No.: US 2010/0264569 A1
(43) Pub. Date: Oct. 21, 2010

(54) LIQUID SEALED-IN TYPE VIBRATION DAMPER

(75) Inventor: Hiroshi Kojima, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Chuo-ku, Tokyo (JP)

(21) Appl. No.: 12/746,046

(22) PCT Filed: Nov. 28, 2008
(86) PCT No.: PCT/JP2008/071708

§ 371 Date: Jun. 3, 2010

(30) Foreign Application Priority Data
Dec. 5, 2007 (JP) 2007-314616

(51) Int. Cl. F16F 13/06; F16F 13/16; F16F 13/10

(52) U.S. Cl. 267/140.11

(57) ABSTRACT

The present invention provides a liquid sealed-in type vibration damper in which a flange-shaped stopper is integrally formed on a core-shaped mounting member in advance so that mounting of a stopper thereon at a later stage is rendered unnecessary. A liquid sealed-in type vibration damper having: a core-shaped mounting member and a sleeve-shaped mounting member connected to the vibration generation side and the vibration-transferred side via brackets, respectively; and a rubber elastic body for connecting the sleeve-shaped mounting member around the core-like mounting member so that relative vibration in the axial direction of the respective mounting members and relative vibration along a direction orthogonal to the axial direction are absorbed, respectively, includes: a flange-shaped stopper formed integral with a portion protruding from the rubber elastic body, of the core-shaped mounting member, for limiting excess displacement of the core-shaped mounting member relative to the sleeve-shaped mounting member in a direction of pulling the core-shaped mounting member out of the sleeve-shaped mounting member by abutment of the stopper on the bracket of the sleeve-shaped mounting member, wherein a surface on the rubber elastic body side of the stopper is designed to be a surface of a truncated cone protruding toward the rubber elastic body side at the center portion of the stopper.

### TECHNICAL FIELD

The present invention relates to what is called a liquid sealed-in type vibration damper for two-way damping, having a core-shaped mounting member and a sleeve-shaped mounting member connected to the vibration generation side and the vibration-transferred side via brackets, respectively, and a rubber elastic body for directly or indirectly connecting the sleeve-shaped mounting member around the core-like mounting member, so that relative vibration in the axial direction of the respective mounting members, e.g. the vertical direction, and relative vibration along a direction orthogonal to the axial direction, e.g. the front-rear direction, are absorbed, respectively. The present invention relates, in particular, to improvement of a stopper for preventing the core-shaped mounting member from being excessively pulled out of the sleeve-shaped mounting member and thus be displaced, in relative displacement between the core-shaped mounting member and the sleeve-shaped mounting member in a direction in which these mounting members are separated from each other.

### PRIOR ART

In a conventional liquid sealed-in type vibration damper for two-way damping of such a type as described above, vibration along the axial direction of the respective mounting members, e.g. the vertical direction, and vibration along a direction orthogonal to the axial direction, e.g. the front-rear direction, are attenuated by liquid column oscillation phenomenon, flow resistance experienced by the liquid, and the like based on flow of the sealed-in liquid through orifices. Specifically, in such a conventional damper as described above, the core-shaped mounting member connected to the sleeve-shaped mounting member by the rubber elastic body is constrained by abutment of a stopper provided on the core-shaped mounting member with the bracket of the sleeve-shaped mounting member to prevent the core-shaped mounting member from being excessively pulled out of the sleeve-shaped mounting member and displaced, so that the rubber elastic body is protected from being damaged.

In this case, the stopper is generally later mounted on the core-shaped mounting member after completion of vulcanization molding of the rubber elastic body, as disclosed in JP 2007-016902, JP 2007-032745 and JP 2007-064352, because two liquid chambers are defined to be positioned to face each other in the radial direction with the core-shaped mounting member therebetween, so that the rubber elastic body serves as a main body for connecting the sleeve-shaped mounting member around the core-shaped mounting member by vulcanization adhesion and, more directly speaking because it is convenient in terms of removal of a vulcanization mold for the rubber elastic body, which removal is associated with formation of end walls, on the stopper side, of the respective liquid chambers by the rubber elastic body.

### DISCLOSURE OF THE INVENTION

### Problems to be Solved by the Invention

Because of the reasons described above, there is a problem in the aforementioned prior art, that increase in cost for a vibration damper is unavoidable due to increase in number of the parts, increase in number of the assembly processes of a stopper and that a fixing portion of the stopper mounted at a later stage on a core-shaped mounting member supported by a rubber elastic body may be loosened to facilitate occurrence of rattling or the like at a relatively early stage of use.

The present invention is to solve such problems as described above of the prior art, and an object thereof is to provide a liquid sealed-in type vibration damper in which a flange-shaped stopper is integrally formed on a core-shaped mounting member in advance so that mounting of a stopper thereon at a later stage is rendered unnecessary.

### Means for Solving the Problems

A liquid sealed-in type vibration damper of the present invention having: a core-shaped mounting member and a sleeve-shaped mounting member connected to the vibration generation side and the vibration-transferred side via brackets, respectively; and a rubber elastic body for directly or indirectly connecting the sleeve-shaped mounting member around the core-like mounting member to, for example, seal between these two mounting members in a liquid-tight manner so that relative vibration in the axial direction of the respective mounting members and relative vibration along a direction orthogonal to the axial direction are absorbed, respectively, comprises: a flange-shaped stopper formed in advance integral with a portion protruding from the rubber elastic body, of the core-shaped mounting member, for limiting excess displacement of the core-shaped mounting member relative to the sleeve-shaped mounting member in a direction of pulling the core-shaped mounting member out of the sleeve-shaped mounting member by abutment of the stopper on the bracket of the sleeve-shaped mounting member; and cover rubber optionally provided for covering a surface of the stopper, wherein either a surface, on the rubber elastic body side, of the stopper or a surface of the cover rubber is designed to be a surface of a truncated cone which protrudes toward the rubber elastic body side at the center portion of the stopper by gradually decreasing at least one of thickness of the stopper itself and thickness of the cover rubber thereon toward the outer side in the radial direction of the stopper.

Preferably, distance along the axial direction between the surface of the truncated cone and a surface of the rubber elastic body facing the surface of the truncated cone is designed to be either be constant toward the outer and inner sides in the radial direction or gradually increase toward the outer side in the radial direction.

Further, the surface on the rubber elastic body side and a surface on the bracket side of the sleeve-shaped mounting portion, of the stopper, are covered by cover rubber integral with the rubber elastic body, respectively.

### Effect of the Invention

In the liquid sealed-in type vibration damper of the present invention, a flange-shaped stopper made of the same material as the core-shaped mounting member is formed in advance integral with the portion protruding from the rubber elastic body, of the core-shaped mounting member, whereby the number of parts for components of the vibration damper can be decreased and the number of the processes required for assembling the stopper can be reduced to zero, as compared with a case where a stopper is mounted on the core-shaped mounting member at a later stage. Further, it is possible to prevent in a satisfactory manner the stopper from being loosened and wobble due to insufficient assembly strength of the stopper, or the like.

In a case where the stopper is formed in advance integral with the core-shaped mounting member, removal of a vulcanization mold for the rubber elastic body which is vulcanization-adhered to the core-shaped mounting member and the sleeve-shaped mounting member, respectively, can be implemented in a sufficiently smooth manner without being interfered by the stopper, by designing at least a portion of the vulcanization mold in the vicinity of the stopper to have a structure constituted of at least two divided portions with a parting face thereof in a plane including the center axis of the core-shaped mounting member such that removal of these divided mold portions after vulcanization molding is carried out by displacement thereof in the radial direction of the flange-shaped stopper. This effect is further enhanced by increasing the number of the divided portions of the vulcanization mold.

In order to realize such mold removal as described above, in a case where the stopper provided on the core-shaped mounting member is used in an exposed manner, it is necessary to structure a surface on the rubber elastic body side of the stopper to be a surface of a truncated cone protruding toward the rubber elastic body side at the center portion of the stopper by gradually decreasing thickness of the stopper itself toward the outer side in the radial direction of the stopper. According to this structure, plural portions of the mold are displaced e.g. in a horizontal plane or in the direction along the surface of the truncated cone, for removal thereof, whereby the plural portions of the mold can be removed in a sufficiently smooth manner, regardless of whether at least one of the mold portions interferes with the rubber elastic body after vulcanization molding or not.

In this case, removal of the mold portions can be carried out in a further smooth manner with avoiding interference between the mold portions and the rubber elastic body portion which has completed vulcanization molding, by either setting the distance along the axial direction of the core-shaped mounting member between the surface of the truncated cone and the surface of the rubber elastic body facing the surface of the truncated cone to be constant toward the inner and outer sides in the radial direction or gradually increasing the distance toward the outer side in the radial direction and, regardless of removing the respective mold portions in a horizontal plane or removing the respective mold portions in a direction along the surface of the truncated cone.

Regarding formation of the surface of the truncated cone, in a case where a surface on the rubber elastic body side of the stopper is covered with cover rubber for use, it is necessary to structure the surface on the rubber elastic body side of the cover rubber to be a surface of a truncated cone protruding toward the rubber elastic body side at the center portion of the stopper by gradually decreasing at least one of thickness of the stopper itself and thickness of the cover rubber toward the outer side in the radial direction of the stopper. The aforementioned structure can cause such an effect as described above. This effect is made distinctive by either setting the distance along the axial direction between the surface of the truncated cone and the surface of the rubber elastic body facing the surface of the truncated cone to be constant toward the inner and outer sides in the radial direction or gradually increasing the distance toward the outer side in the radial direction.

In the present invention, in a case where a surface on the rubber elastic body side and a surface on the bracket side of the sleeve-shaped mounting portion, of the stopper, are covered by cover rubber for alleviating collision sound, impact and the like, cost for the vibration damper can be reduced by adopting a structure in which the cover rubber is integral with the rubber elastic body and thus simplifying the production processes of the vibration damper and reducing the number of required parts, as compared with a case where a cover molded and vulcanized separately is later mounted to the stopper.

### BRIEF DESCRIPTION OF THE DRAWINGS

FIG. 1 is a sectional plan view cut along I-I line of FIGS. 2 and 3, showing an embodiment of the present invention.

FIG. 2 is a sectional side view cut along line II-II of FIG. 1.

FIG. 3 is a sectional side view showing, with a bracket, a section cut along III-III line of FIG. 1.

FIG. 4 is a schematic line sectional view showing an example of mold removal of a vulcanization mold.

FIG. 5 is a schematic line sectional view showing another example of mold removal of a vulcanization mold.

FIG. 6 is a schematic line sectional view showing an example of arrangement of cover rubber.

### BEST MODE FOR IMPLEMENTING THE INVENTION

An embodiment of a liquid sealed-in type vibration damper of the present invention will be described with reference to drawings.

Hereinafter, orthogonal coordination systems are employed in the vibration damper and, for example, +Z direction represents the vehicle downward direction in parallel with the center axis of the vibration damper (e.g. the input direction of the engine weight), +X direction represents the vehicle front direction orthogonal to the center axis, and +Y direction represents the vehicle right hand-side direction orthogonal to the center axis.

In the present embodiment, a liquid sealed-in type vibration damper for two-way attenuation, which is effective for attenuation of vibration in ±Z direction and ±X direction, will be described as an example.

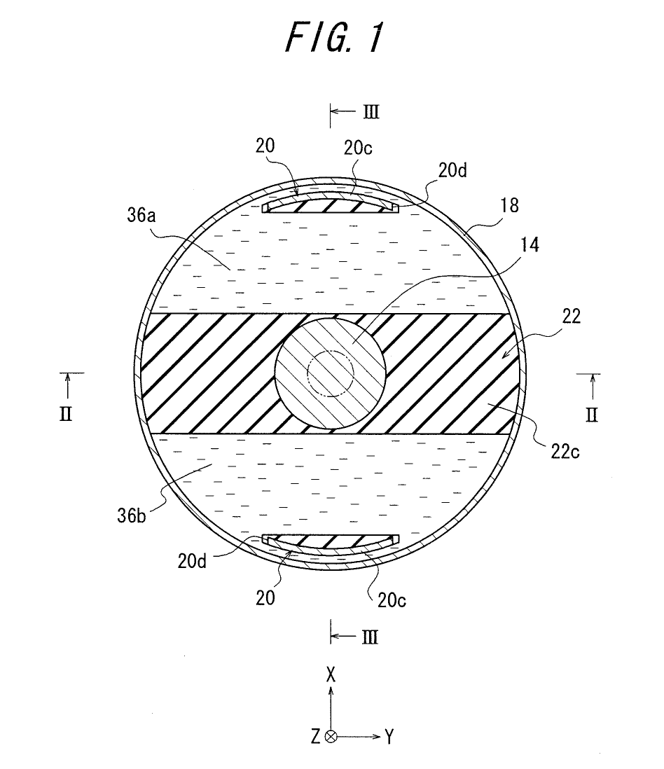

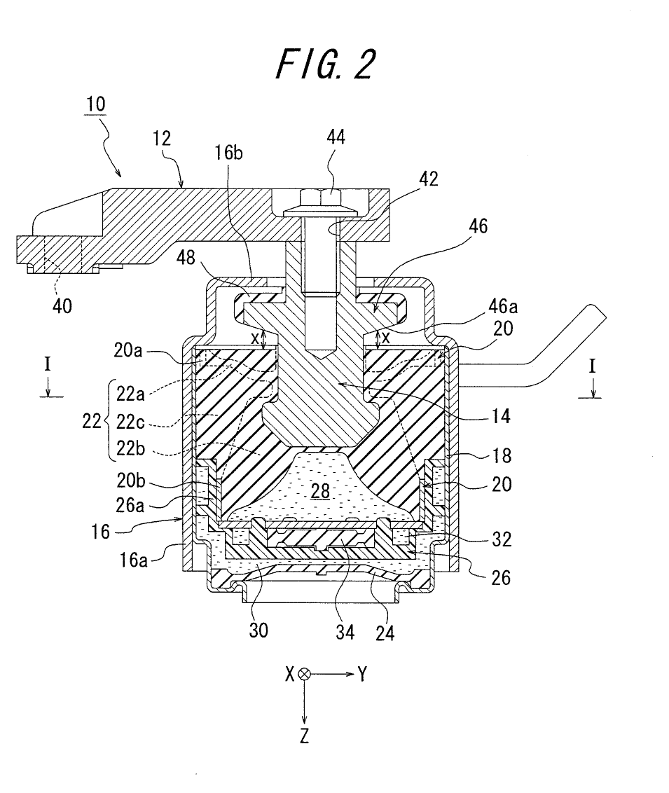

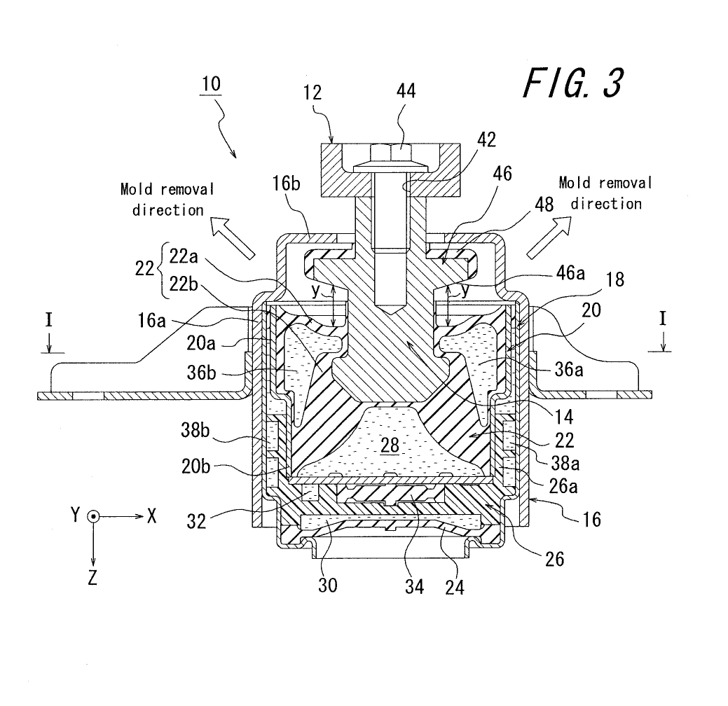

FIGS. 1 to 3 are explanatory views showing an embodiment of the present invention. FIG. 1 is a sectional plan view (a first bracket is not shown) cut along I-I line of FIGS. 2 and 3. FIG. 2 is a sectional side view cut along line II-II of FIG. 1. FIG. 3 is a sectional side view cut along III-III line of FIG. 1.

The liquid sealed-in type vibration damper 10 includes a core-shaped mounting member (a second mounting member) 14 connected to an engine (i.e. the vibration generation side) by way of a second bracket 12, as shown, for example, in FIG. 2.

A screw hole for connecting the core-shaped mounting member 14 to the engine is formed at the end surface on the −Z side, i.e. the upper side in FIG. 2, of the core-shaped mounting member 14. The large-diameter end portion on the +Z side, i.e. the downward side in FIG. 2, of the core-shaped mounting member 14 is tapered like a reversed truncated cone in the downward direction in the drawing and terminates.

A sleeve-shaped mounting member (a first mounting member) 18 to be connected to the vehicle (i.e. the vibration-transferred side) is provided on the outer peripheral side of the core-shaped mounting member 14 by way of a first bracket 16. The sleeve-shaped mounting member 18 is disposed to be coaxial with the core-shaped mounting member 14.

An intermediate cylindrical member 20 described below is provided along the inner periphery of the sleeve-shaped mounting member 18.

In the present embodiment, a rubber elastic body is provided between the core-shaped mounting member 14 and the sleeve-shaped mounting member 18 such that these two mounting members are elastically connected with each other.

The rubber elastic body 22 as shown in the drawings is vulcanization-adhered to the core-shaped mounting member 14 and the intermediate cylindrical member 20, respectively.
The vibration damper 10 supports the weight of the engine inputted on the core-shaped mounting member 14 substantially in parallel with the center axis of the sleeve-shaped mounting member 18 by elastic deformation of the rubber elastic body 22.
The rubber elastic body 22 closes the opening on the −Z side of the sleeve-shaped mounting member 18.

On the other hand, the opening on the +Z side of the sleeve-shaped mounting member 18 is liquid-tight sealed by a diaphragm 24 constituted of a flexible rubber film.

Further, a section member 26 for dividing the internal space of the sleeve-shaped mounting member 18 into two in the axial direction thereof is provided between the rubber elastic body 22 and the diaphragm 24.

Liquid is sealed in on the inner side of the sleeve-shaped mounting member 18 so that a main liquid chamber 28 is formed between the rubber elastic body 22 and the section member 26 and an auxiliary liquid chamber 30 is formed between the section member 26 and the diaphragm 24, respectively.

In the present embodiment, an annular main orifice flow path 32 is formed in the section member 26. An end of the main orifice flow path 32 opens to the main liquid chamber 28 and the other end thereof opens to the auxiliary liquid chamber 30.

When the core-shaped mounting member 14 vibrates in the ±Z directions in association with primary vibration of the engine, the liquid in the main liquid chamber 28 and the liquid in the auxiliary liquid chamber 30 move between the chambers through the main orifice flow path 32. In this case, when the core-shaped mounting member 14 vibrates at a first resonance frequency (e.g. around 10 Hz of engine shake), the liquid in the main orifice flow path 32 exhibits liquid column oscillation, whereby a significant effect of attenuating vibration caused by the engine in the ±Z directions can be demonstrated.

A membrane 34 constituted of a rubber elastic film is disposed at the center portion of the section member 26. The −Z side face of the membrane 34 communicates with the main liquid chamber 28 and the +Z side face communicates with the auxiliary liquid chamber 30. The membrane 34 is structured and supported such that at least a portion thereof is capable of being deformed or displaced in the ±Z directions.

When the core-shaped mounting member 14 vibrates at a frequency exceeding the first resonance frequency described above (e.g. around 35 Hz of idling vibration), the liquid inside the main orifice flow path 32 can no longer passively move, whereby the pressures inside the main liquid chamber 28 and the auxiliary liquid chamber 30 rise up. Such increase in internal pressures of the liquid chambers can be absorbed by deformation or the like in the vibrating direction, of the membrane 34. Accordingly, increase in dynamic spring constant of an engine mount can be suppressed.

As shown in FIG. 2, the intermediate cylindrical member 20 has an upper cylindrical portion 20a disposed in the −Z direction and a lower cylindrical portion 20b disposed in the +Z direction. The upper cylindrical portion 20a and the lower cylindrical portion 20b are connected with each other by a pair of connection portions 20c.

The pair of connection portions 20c are disposed in the ±X direction of the intermediate cylindrical member 20. Therefore, a pair of window portions 20d are formed in the ±Y direction of the intermediate cylindrical member 20.

Further, as shown in FIG. 2, the rubber elastic body 22 is constituted of an upper wall portion 22a, a lower wall portion 22b and a section wall portion 22c. In the present embodiment, the upper wall portion 22a is provided between the core-shaped mounting member 14 and the upper cylindrical portion 20a of the intermediate cylindrical portion 20 around the entire peripheries thereof, and the lower wall portion 22b is provided between the core-shaped mounting member 14 and the lower cylindrical portion 20b of the intermediate cylindrical portion 20 around the entire peripheries thereof. The section wall portion 22c is formed to connect the upper wall portion 22a and the lower wall portion 22b at positions facing each other in the diameter direction of the core-shaped mounting member 14.

The section wall portion 22c extends from the core-shaped mounting member 14 in the ±Y direction, penetrates through the window portions 20d of the intermediate cylindrical member 20 and is in contact with the inner surface of the sleeve-shaped mounting member 18, as shown in FIG. 1.

In the vibration damper shown in the drawings, the outer peripheral surface of the section wall portion 22c and the inner peripheral surface of the sleeve-shaped mounting member 18 are set in a non-adhesion state with each other by caulking fixation or the like of the sleeve-shaped mounting member 18 with respect to the intermediate cylindrical member 20.

Accordingly, when the core-shaped mounting member 14 is significantly displaced in the +Y direction, the section wall portion 22c is moved away from the sleeve-shaped mounting member 18 in the −Y direction of the core-shaped mounting member 14. As a result, tensile strain in the −Y direction of the section wall portion 22c is reduced and generation of cracks can be prevented.

In a case where the core-shaped mounting member 14 vibrates at a relatively small amplitude in the ±X direction, the section wall 22c does not move away from the sleeve-shaped mounting member 18. Therefore, the attenuation characteristics in the ±X directions do not deteriorate due to “short circuit” of the first liquid chamber 36a and the second liquid chamber 36b separated in the ±X direction by the section wall portion 22c around the core-shaped mounting member 14.

As shown in FIG. 3, the first liquid chamber 36a and the second liquid chamber 36b are formed between the upper wall portion 22a and the lower wall portion 22b, respectively.

The section member 26 includes a cylindrical portion 26a provided to stand from the peripheral end of the section member 26 along the inner surface of the sleeve-shaped mounting member 18. The cylindrical portion 26a is provided with a first orifice flow path 38a for communication between the first liquid chamber 36a and the auxiliary liquid chamber 30 and a second orifice flow path 38b for communication between the second liquid chamber 36b and the auxiliary chamber 36 (30).

When the core-shaped mounting member 14 vibrates in the ±X direction in association with secondary vibrations of the engine, the liquid in the first liquid chamber 36a and the liquid in the auxiliary liquid chamber 30 mutually move through the first orifice flow path 38a, and the liquid in the second liquid chamber 36b and the liquid in the auxiliary liquid chamber 30 mutually move through the second orifice flow path 38b. Then, when the core-shaped mounting member 14 vibrates at a second resonance frequency, the liquid in the first orifice flow path 38a and the liquid in the second orifice flow path 38b exhibit liquid column oscillation. Accordingly, a significant effect of attenuating vibration caused by the engine in the ±X directions can be demonstrated.

The liquid in the first orifice flow path 38a and the liquid in the second orifice flow path 38b also exhibit liquid column oscillation in a case where the core-shaped mounting member 14 vibrates at the second resonance frequency in the ±Z directions. Accordingly, a significant effect of attenuating vibration caused by the engine in the ±Z directions can be demonstrated in relatively wide range from the first resonance frequency to the second resonance frequency.

As described above, the vibration damper of the present embodiment is what is called a vibration damper for two-way damping.

Specifically, the vibration damper 10 includes: the sleeve-shaped mounting member 18 connected to a vehicle body and formed to be substantially cylindrical; the core-shaped mounting member 14 connected to an engine and disposed on the inner peripheral side of the sleeve-shaped mounting member 18; the rubber elastic body 22 provided between the sleeve-shaped mounting member 18 and the core-shaped mounting member 14 for elastically connecting these two mounting members; the main liquid chamber 28 provided on the inner peripheral side of the sleeve-shaped mounting member 18 and (in the drawings) on the further lower side than the lower end of the core-shaped mounting member 14 such that at least a portion thereof is sectioned by the rubber elastic body 22 to be filled with liquid; the auxiliary liquid chamber 30 in which a portion of the section wall thereof is formed by the diaphragm 24, liquid is filled therein and the inner volume thereof can be increased/decreased in accordance with change in liquid pressure of the liquid; and the main orifice flow path 32 for mutual communication between the main liquid chamber 28 and the auxiliary liquid chamber 30 to allow the liquid to flow therebetween. The vibration damper 10 further includes: the first liquid chamber 36a and the second liquid chamber 36b provided between the sleeve-shaped mounting member 18 and the core-shaped mounting member 14, respectively, such that at least portions of the inner walls thereof are made of rubber and these liquid chambers are filled with liquid; the first orifice flow path 38a for communication of the first liquid chamber 36a with the auxiliary liquid chamber 30; and the second orifice flow path 38b for communication of the second liquid chamber 36b with the auxiliary liquid chamber 30.

Further, in the liquid sealed-in type vibration damper of the drawings, as shown in FIG. 2, the second bracket 12 is mounted at the tip end, on the side protruding from the sleeve-shaped mounting member 18, of the core-shaped mounting member 14. The second bracket 12, having a rod-like shape as a whole, includes an insertion hole 40 for inserting a bolt fastened to the engine at one (−Y side) end portion thereof and a through hole 42 for inserting a bolt with which the bracket 12 is fastened to the core-shaped mounting member 14.

Accordingly, the second bracket 12 is fixed to the core-shaped mounting member 14 by way of a bolt 44 inserted into the through hole 42.

Yet further, in the present embodiment, a stopper 46 (a rebound stopper) is provided in advance to be integral with a portion protruding from the rubber elastic body 22 (protruding upward in the drawings) of the core-shaped mounting member 14, for limiting excessive displacement in position of the core-shaped mounting member 14 relative to the sleeve-shaped mounting member 18 in the direction (the −Z direction) of pulling the core-shaped mounting member 14 out of the sleeve-shaped mounting member 18 by abutment of the stopper 46 with the first bracket 16 for the sleeve-shaped mounting member 18, specifically, with the inner flange 16b formed at the end portion of the cylindrical portion 16a of the first bracket 16 fixed around the sleeve-shaped mounting member 18 by caulking or the like in the drawings.

The stopper 46 can be made to function, by appropriately setting the diameter thereof and the inner diameter of an end portion of the cylindrical end portion 16a adjacent to the inner flange 16b, as a stopper for limiting excessive relative displacement of the core-shaped mounting member 14 in the vehicle front-rear direction (±X direction) and/or the lateral direction (±Y direction) by abutment of the stopper with a portion of the cylindrical portion adjacent thereto.

In each case as described above, it is preferable to cover at least the abutment surface of the stopper 46 with an impact mitigating material such as cover rubber 48 in order to mitigate or suppress abutment sound, abutment impact and the like, which are caused when the stopper 46 functions.

In this case, the cover rubber 48 may be either adhered to the stopper 46 surface by vulcanization adhesion or the like or set in a non-adhesion state with the stopper 46. Alternatively, an impact mitigating material may be provided not on the stopper 46 but on the side of the first bracket 16.

In order to facilitate smooth removal of the vulcanization mold for vulcanization-molding the rubber elastic body 22 to vulcanization-adhere the rubber elastic body to the respective mounting members 14, 18 in a state where the stopper 46 has been formed in advance integral with the core-shaped mounting member 14, a surface on the rubber elastic body 22 side of the stopper 46 is designed to be a surface 46a of a truncated cone protruding toward the rubber elastic body 22 side at the center portion of the flange-like stopper 46.

In the present embodiment, it is further preferable to set the distance x, y between the surface 46a of the truncated cone and a surface of the rubber elastic body 22 facing the surface 46a of the truncated cone along the axial direction of the core-shaped mounting member 14 to be constant on the inner and outer sides in the radial direction or gradually increase the distance x, y toward the outer side in the radial direction.

In the present embodiment, the aforementioned surface 46a of the truncated cone of the stopper 46 can be formed by gradually decreasing thickness of the stopper itself in either linear or curved manner on the side of a surface facing the rubber elastic body 22 thereof toward the outer side in the radial direction of the stopper 46. Accordingly, the surface 46a of the truncated cone of the present embodiment includes a curved surface which is somewhat protruding or recessed with respect to the rubber elastic body 22, as well as a geometrically tapered surface of a truncated cone.

In the case where the stopper 46 is structured as described above, at least a mold portion contributing to vulcanization molding of the rubber elastic body 22 (the upper portion in the drawings) of the vulcanization mold for the rubber elastic body 22 has, in planes including the center axis of the core-shaped mounting member 14, plural parting faces in the radial direction, whereby the mold portion can have a structure where the mold portion is constituted of at least two divided portions each capable of being displaced in the radial direction or the like of the stopper 46 for removal of the mold.

FIG. 4 shows one example of the aforementioned structure by a schematic line sectional view in a state where the sleeve-shaped mounting member, the section member and the like have been removed from the vibration damper. As shown in FIG. 4, a mold portion 50 contributing to vulcanization molding of the upper half portion of the rubber elastic body 22 possesses a structure in which the mold portion 50 has a parting face in a plane including the center axis of the core-shaped mounting member 14, so that the mold portion 50 is constituted of two divided portions 50a, 50b capable of being displaced in the left-right direction in FIG. 4 for removal of the mold.

According to the mold portion 50, the divided portions 50a, 50b are displaced in the left-right direction for removal of the mold after completion of vulcanization molding of the rubber elastic body 22, whereby removal of the mold portion can be realized in a sufficiently smooth manner, with the stopper 46 provided on the core-shaped mounting member 14.

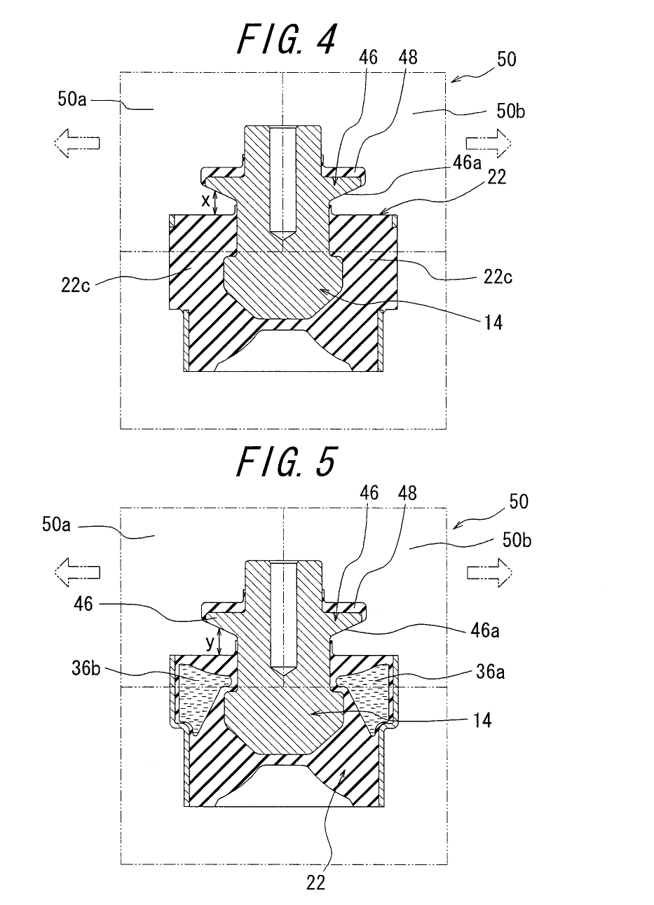

In a case where the mold portion 50 is structured to be constituted of two divided portions, it is possible to structure the mold portion to be displaced in the left-right direction of FIG. 5 for removal of the mold. In a case where the mold portion 50 is structured to be constituted of three or more divided portions capable of being displaced in the radial direction with respect to the center axis of the core-shaped mounting member 14 for removal of the mold, removal of the mold can be smoothly carried out even in a case where some dents or recesses exist in the circumferential direction at the upper surface of the rubber elastic body 22.

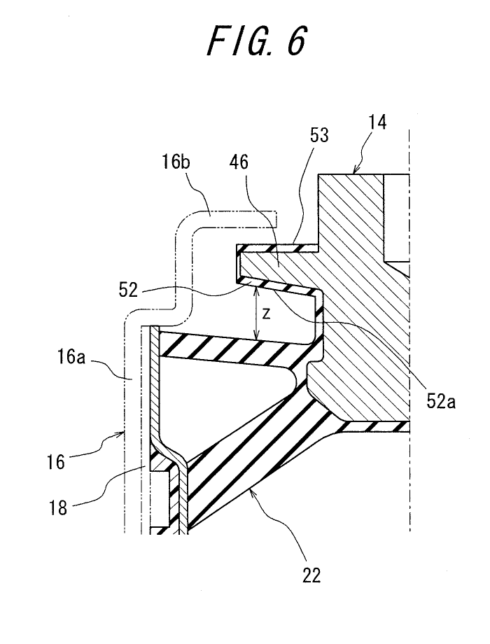

As shown in FIG. 6, the stopper 46 is provided with cover rubber 52 for covering a surface on the rubber elastic body 22 side thereof, and a surface on the rubber elastic body 22 side of the cover rubber 52 is designed to be a surface 52a of a truncated cone protruding on the rubber elastic body 22 side at the center portion of the stopper 46 and the distance z between the surface 52a of the truncated cone and a surface of the rubber elastic body facing the surface 52a of the truncated cone along the axial direction of the core-shaped mounting member 14 is set to be constant in the inner and outer directions or gradually increase toward the outer side in the radial direction, as described above. The required surface 52a of the truncated cone can be realized by: gradually decreasing thickness of the stopper itself toward the outer side in the radial direction of the stopper 46, as shown in FIG. 6; or gradually decreasing thickness of the cover rubber toward the outer side in the radial direction of the stopper 46, without gradually decreasing thickness of the stopper 46; or gradually decreasing thickness of the cover rubber, as well as thickness of the stopper 46, toward the outer side in the radial direction of the stopper 46.

Smooth and reliable mold removal can be carried out by employing the aforementioned mold portion structure constituted of divided portions, in such cases as described above.

In the present embodiment, in a case where cover rubber 53 is provided at a surface of the stopper 46 facing the first bracket 16, in addition to the aforementioned cover rubber 52 provided at the surface of the stopper 46 facing the rubber elastic body 22, as shown in FIG. 6, it is preferable to form these cover rubbers 52, 53 integral with the rubber elastic body 22 as shown in the drawing in terms of simplifying the production process.

1. A liquid sealed-in type vibration damper having: a core-shaped mounting member and a sleeve-shaped mounting member connected to the vibration generation side and the vibration-transferred side via brackets, respectively; and a rubber elastic body for connecting the sleeve-shaped mounting member around the core-like mounting member so that relative vibration in the axial direction of the respective mounting members and relative vibration along a direction orthogonal to the axial direction are absorbed, respectively, comprising:
a flange-shaped stopper formed integral with a portion protruding from the rubber elastic body, of the core-shaped mounting member, for limiting excess displacement of the core-shaped mounting member relative to the sleeve-shaped mounting member in a direction of pulling the core-shaped mounting member out of the sleeve-shaped mounting member by abutment of the stopper on the bracket of the sleeve-shaped mounting member; and
wherein either a surface on the rubber elastic body side of the stopper or a surface of a cover rubber covering said surface on the rubber elastic body side of the stopper is designed to be a surface of a truncated cone protruding toward the rubber elastic body side at the center portion of the stopper.

2. The liquid sealed-in type vibration damper of claim 1, wherein distance along the axial direction between the surface of the truncated cone and a surface of the rubber elastic body facing the surface of the truncated cone is designed to either be constant toward the outer and inner sides in the radial direction or gradually increase toward the outer side in the radial direction.

3. The liquid sealed-in type vibration damper of claim 1, wherein the surface on the rubber elastic body side and a surface on the bracket side of the sleeve-shaped mounting portion, of the stopper, are covered by cover rubber integral with the rubber elastic body, respectively.

4. The liquid sealed-in type vibration damper of claim 2, wherein the surface on the rubber elastic body side and a surface on the bracket side of the sleeve-shaped mounting portion, of the stopper, are covered by cover rubber integral with the rubber elastic body, respectively.
